(19) United States
(12) Patent Application Publication
(10) Pub. No.: US 2017/0356553 A1
(43) Pub. Date: Dec. 14, 2017

(54) ADJUSTABLE ORIFICE VALVE

(71) Applicant: EcoTec Solutions, Inc., Colton, CA (US)

(72) Inventors: Mitchal Cassel, Redlands, CA (US); Jamie Tooley, Beaumont, CA (US); Scott Marcell, Banning, CA (US)

(21) Appl. No.: 15/619,273

(22) Filed: Jun. 9, 2017

Related U.S. Application Data
(60) Provisional application No. 62/348,422, filed on Jun. 10, 2016.

(51) Int. Cl. F16K 3/02; F16K 37/00; F16K 31/04; F16K 31/53

(52) U.S. Cl. CPC F16K 3/0209; F16K 31/535; F16K 37/005; F16K 31/043; F16K 37/0058; F16K 37/0041

(57) ABSTRACT

An adjustable orifice valve system is disclosed which comprises an iris valve to control flow rate through the system, and a slide valve to prevent leaks through the system. Both valves can be adjusted through a gear train manually via a handle and/or automatically via a motor. When the iris valve is in a minimally open configuration, the gear train engages the slide valve to permit or disallow flow through the slide valve. When the iris valve is in a partially or maximally open configuration, an opening in the slide valve is aligned with the flow axis of the system to permit uninhibited flow through the slide valve. The position of the handle can indicate aperture size of the iris valve and/or position of the slide valve. In some embodiments, a pressure transducer and/or gear position sensor can provide determination of flow rate through the valve system.

### INCORPORATION BY REFERENCE TO ANY PRIORITY APPLICATIONS

This application claims the benefit of U.S. Provisional Application Ser. No. 62/348,422, filed Jun. 10, 2016, entitled “ADJUSTABLE ORIFICE VALVE,” which is hereby incorporated by reference in its entirety and for all purposes.

### BACKGROUND

Various entities utilize fluid transport systems to transport fluids such as liquids or gases (e.g., natural gas, biogas, etc.). For example, energy developers, petroleum companies, coal mines, landfills, and various other entities may utilize fluid transport systems. It may be desirable to control the flow rate of a fluid through a fluid flow pipe or other component of a fluid transport system.

### SUMMARY

The present disclosure relates to systems and methods for controlling fluid flow rate, and more specifically to adjustable valves for use in fluid transport systems.

The systems and methods of this disclosure each have several innovative aspects, no single one of which is solely responsible for its desirable attributes. Without limiting the scope as expressed by the claims that follow, its more prominent features will now be discussed briefly.

In a first embodiment, a flow control valve is described. The flow control valve includes an intake socket, an outlet socket, an iris valve configured for positioning between the intake socket and the outlet socket, and a slide valve configured for positioning between the intake socket and the outlet socket. The iris valve includes adjustable orifice plates with planes substantially perpendicular to a flow axis of the flow control valve such that the adjustable orifice plates define an aperture. The slide valve is configured to slide in a direction substantially perpendicular to the flow axis of the flow control valve. A gear wheel mechanism engages the iris valve to adjust the size of the aperture through rotational motion. The gear wheel mechanism engages the slide valve for sliding motion.

The gear wheel mechanism can be configured to engage the slide valve for sliding motion when the iris valve is in a minimally open configuration. The gear wheel mechanism can be configured to engage the iris valve to adjust the size of the aperture when the slide valve is in an open position.

The flow control valve can further include a housing at least partially enclosing the gear wheel mechanism, and a handle coupled through the housing to actuate the gear wheel mechanism. The housing can include an exterior surface having one or more markings configured to visually indicate, based on a position of the handle, one or more of a size of the aperture, an open or closed position, or a fluid flow rate. A continuous motion of the handle can consecutively induce a sliding motion of the slide valve and an aperture size adjustment of the iris valve. The flow control valve can further include a motor coupled to the gear wheel mechanism, wherein the motor is configured to actuate the gear wheel mechanism.

The flow control valve can further include a valve position sensor configured to produce an output indicative of a size of the aperture. The flow control valve can further include a pressure sensor configured to produce an output indicative of a fluid pressure within an interior space of the flow control valve. The flow control valve can further include processing circuitry configured to calculate a rate of fluid flow through the flow control valve based at least in part on the output of the pressure sensor.

In a second embodiment, a fluid flow control device is described. The fluid flow control device includes a housing generally defining a fluid space, the housing comprising a fluid inlet and a fluid outlet spaced from the fluid inlet along a fluid flow axis. The fluid flow control device further includes coarse adjustment means for coarsely adjusting a flow rate along the fluid flow axis, and fine adjustment means for finely adjusting the flow rate along the fluid flow axis, wherein the coarse adjustment means and the fine adjustment means are at least partially disposed within the housing along the fluid flow axis.

The coarse adjustment means can be configured to substantially prevent fluid flow through the fluid flow control device when in a closed position. The fine adjustment means can include one or more structures defining an aperture and means for adjusting a diameter of the aperture. The coarse adjustment means can be configured to transition between a closed position and a fully open position when the fine adjustment means is in a minimally open position. The fine adjustment means can be configured to transition between a fully open position and a minimally open position when the coarse adjustment means is in a fully open position.

### BRIEF DESCRIPTION OF THE DRAWINGS

The above-mentioned aspects, as well as other features, aspects, and advantages of the present technology will now be described in connection with various implementations, with reference to the accompanying drawings. The illustrated implementations are merely examples and are not intended to be limiting. Throughout the drawings, similar symbols typically identify similar components, unless context dictates otherwise.

FIGS. 1A and 1B are perspective views of embodiments of an adjustable orifice valve system in accordance with exemplary embodiments.

FIGS. 2A and 2B are partially exploded views of embodiments of the adjustable orifice valve systems of FIGS. 1A and 1B, respectively.

FIGS. 3A and 3B are exploded views of the example adjustable orifice valve systems of FIGS. 1A and 2A, and FIGS. 1B and 2B, respectively.

FIGS. 4A and 4B are cutaway views of the example adjustable orifice valve system of FIGS. 1A, 2A, and 3A; and FIGS. 1B, 2B, and 3B, respectively, illustrating components of gear wheel systems of the adjustable orifice valve systems.

FIGS. 5A and 5B are cross sectional views of the adjustable orifice valve systems of FIGS. 1A, 2A, 3A, and 4A; and FIGS. 1B, 2B, 3B, and 4B, respectively.

FIGS. 6A and 6B are cross sectional views of the adjustable orifice valve systems of FIGS. 1A, 2A, 3A, 4A, and 5A; and FIGS. 1B, 2B, 3B, 4B, and 5B, respectively, taken perpendicular to the cross sectional views of FIGS. 5A and 5B, respectively.

FIG. 7 illustrates an exemplary adjustable orifice plate and adjustment mechanism for adjusting the orifice plate.

FIG. 8 illustrates components of the adjustable orifice plate of FIG. 7 in a fully open configuration.

FIGS. 9A-9C illustrate an exemplary process of adjusting the size of an orifice using the adjustable orifice plate of FIGS. 7 and 8.

### DETAILED DESCRIPTION

The following description is directed to certain implementations for the purpose of describing the innovative aspects of this disclosure. However, a person having ordinary skill in the art will readily recognize that the teachings herein can be applied in a multitude of different ways. The described implementations may be implemented in any gas detection and/or analysis system.

Generally described, aspects of the present disclosure relate to an adjustable orifice valve that may include an iris-type valve for fine adjustments of flow rate and/or a slide valve for more coarse adjustments of the flow rate and/or complete restriction of fluid flow. In some aspects, a coarse fluid flow rate adjustment valve, such as a slide valve or the like, may be poorly suited to accurately provide fine-scale flow rate adjustment. A fine fluid flow rate adjustment valve, such as an iris valve, may be poorly suited for providing coarse flow rate adjustment and/or for completely shutting off flow of fluid, for example, to prevent leaks when no fluid flow is desired. Accordingly, it may be desirable to provide a fluid flow control valve capable of accurate fine-scale adjustment of fluid flow and capable of effectively preventing leakage when in a closed position.

For purposes of illustration, an example adjustable orifice valve is discussed herein as including an iris valve and a slide valve. However, other adjustable orifice valves may not include all of the components or features discussed in the examples herein, such as the slide valve.

In some embodiments, the adjustable orifice valve (also referred to herein as the “flow valve system”) can be useful to entities transporting fluid (including gas such as natural gas, biogas, etc.) to control flow rate through the system. Such entities include energy developers, petroleum companies, coal mines, landfills, just to give a few examples. The valve system can support flow rate control of fluids at various pressures, e.g., within ±10 psi relative to standard pressure. The adjustable orifice valve may be used in any other fluid transport system.

The above-mentioned aspects, as well as other features, aspects, and advantages of the present technology will now be described in connection with various embodiments, with reference to the accompanying drawings. The illustrated embodiments, however, are merely examples and are not intended to be limiting. Like reference numbers and designations in the various drawings indicate like elements.

In the following detailed description, reference is made to the accompanying drawings, which form a part of the present disclosure. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, illustrated in the figures, can be arranged, substituted, combined, and designed in a wide variety of different configurations, all of which are explicitly contemplated and form part of this disclosure. For example, a system or device may be implemented or a method may be practiced using any number of the aspects set forth herein. In addition, such a system or device may be implemented or such a method may be practiced using other structure, functionality, or structure and functionality in addition to or other than one or more of the aspects set forth herein. Alterations in further modifications of the inventive features illustrated herein, and additional applications of the principles of the inventions as illustrated herein, which would occur to one skilled in the relevant art and having possession of this disclosure, are to be considered within the scope of the invention.

Descriptions of the necessary parts or elements may be omitted for clarity and conciseness, and like reference numerals refer to like elements throughout. In the drawings, the size and thickness of layers and regions may be exaggerated for clarity and convenience.

### An Exemplary Adjustable Orifice Valve System

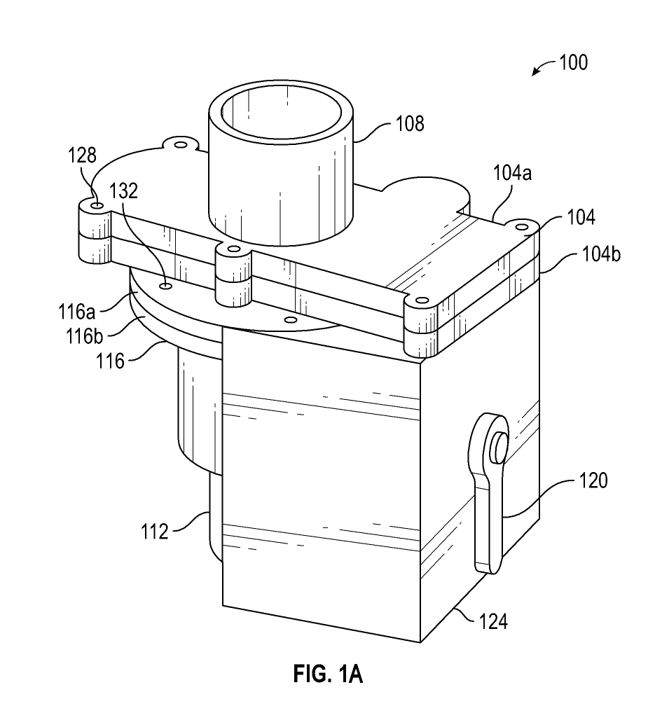

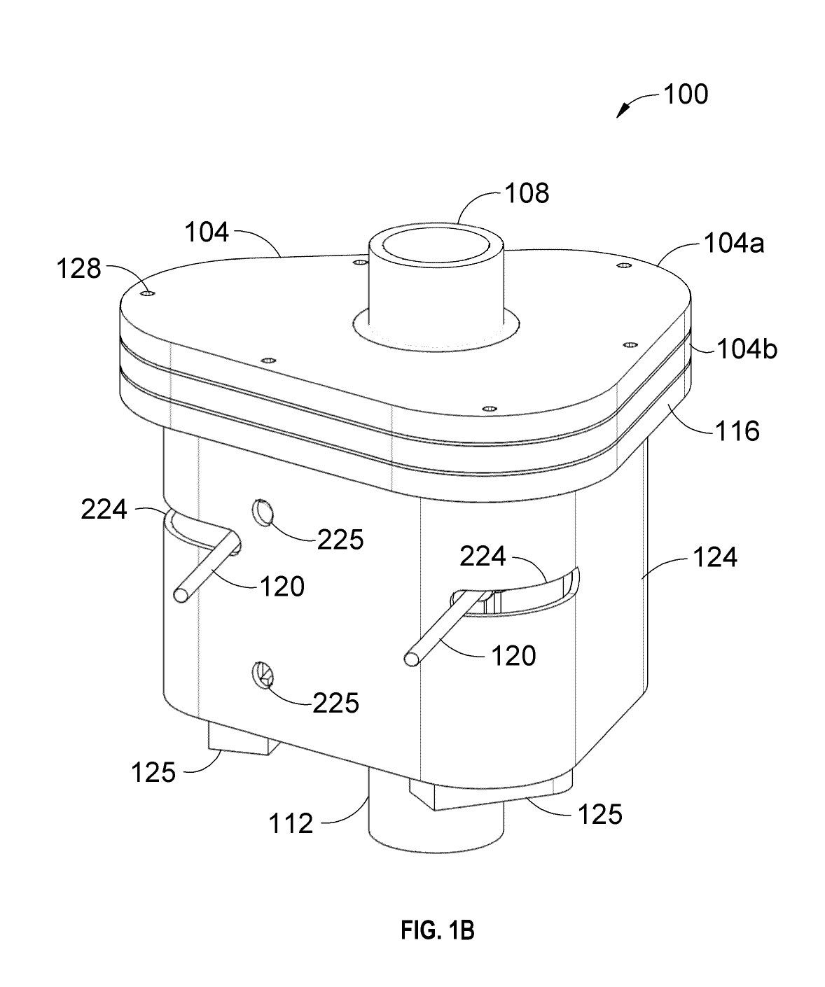

FIG. 1A illustrates a perspective view of one embodiment of an adjustable orifice valve system 100. The exemplary system comprises an intake socket 108 and an outlet socket 112 sized for coupling with external fluid flow pipes. The inner circumferences of the intake and outlet sockets can be, but need not be, of the same size. For example, the socket connected to the source of fluid (e.g., the intake socket 108) can have a larger inner circumference than the socket connected to the destination of the fluid (e.g., the outlet socket 112). The intake and outlet sockets can mate with pipes (e.g., with or without connectors/adapters) to incorporate the valve system 100 to provide flow control within any fluid flow system. Such pipes can be substantially cylindrical in shape. The valve system can support pipes of different sizes, for example, pipes with an interior or exterior diameter within the range of 0.5 inches to 6 inches, 1 inch to 3 inches, or other suitable range.

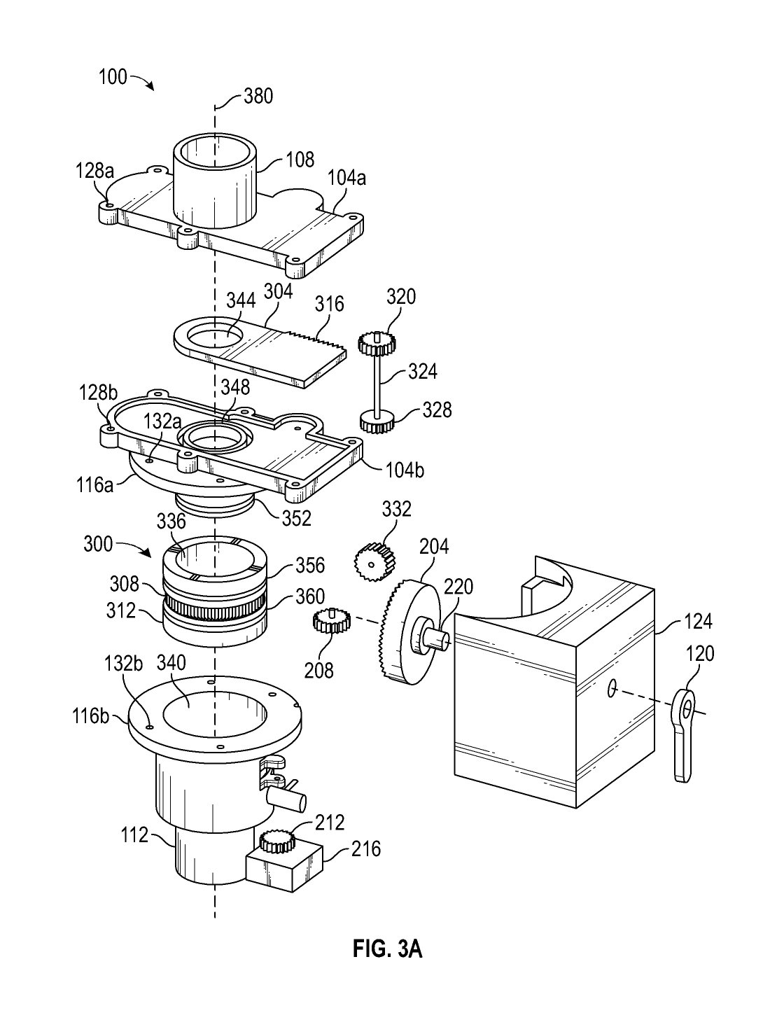

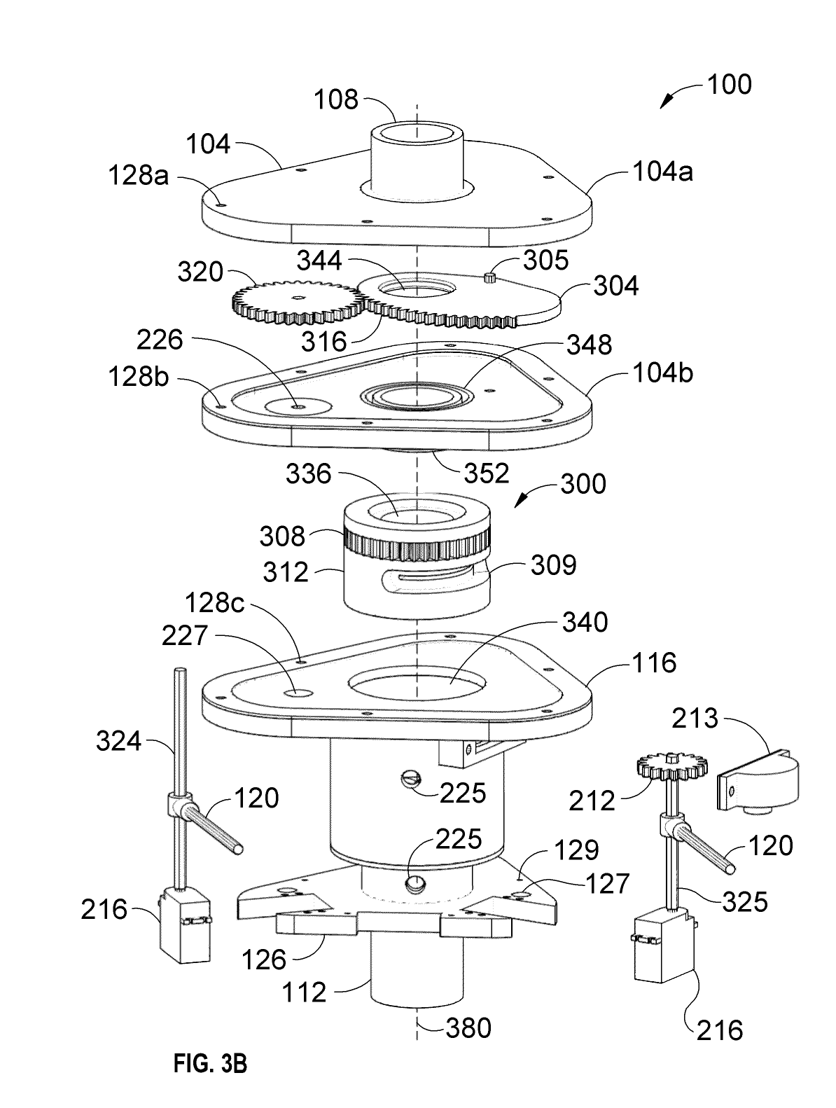

The valve system 100 includes an upper flange 104 disposed near or adjacent to the intake socket 108. The upper flange 104 comprises an upper piece 104a and a lower piece 104b. As will be described below with reference to FIGS. 3-5, the upper piece 104a and lower piece 104b may be shaped to define an interior space such that a generally planar slide valve can be placed between the upper piece 104a and the lower piece 104b of the upper flange. A lower flange 116 is disposed near or adjacent to the upper flange 104 and can provide structural support for the outlet socket 112. The lower flange comprises an upper piece 116a and a lower piece 116b. In some aspects, the upper piece 116a can be formed as a single piece with the lower piece 104b of the upper flange, such as by plastic molding. One or more openings 128 for fasteners, e.g., screws or bolts, may be placed around the perimeters of the upper flange to securely join the upper and lower pieces of the upper flange together with fasteners. Similarly, one or more openings 132 may be placed around the perimeters of the lower flange to securely join the upper and lower pieces of the lower flange together with fasteners. In some embodiments, the upper and/or lower flange may have o-ring seals or gaskets close to their/its perimeters. Various embodiments may have more or fewer openings for fasteners than the exemplary valve system 100 illustrated in FIG. 1A. Various embodiments may place the openings at different locations than illustrated in FIG. 1A, e.g., within the perimeters of the upper flange.

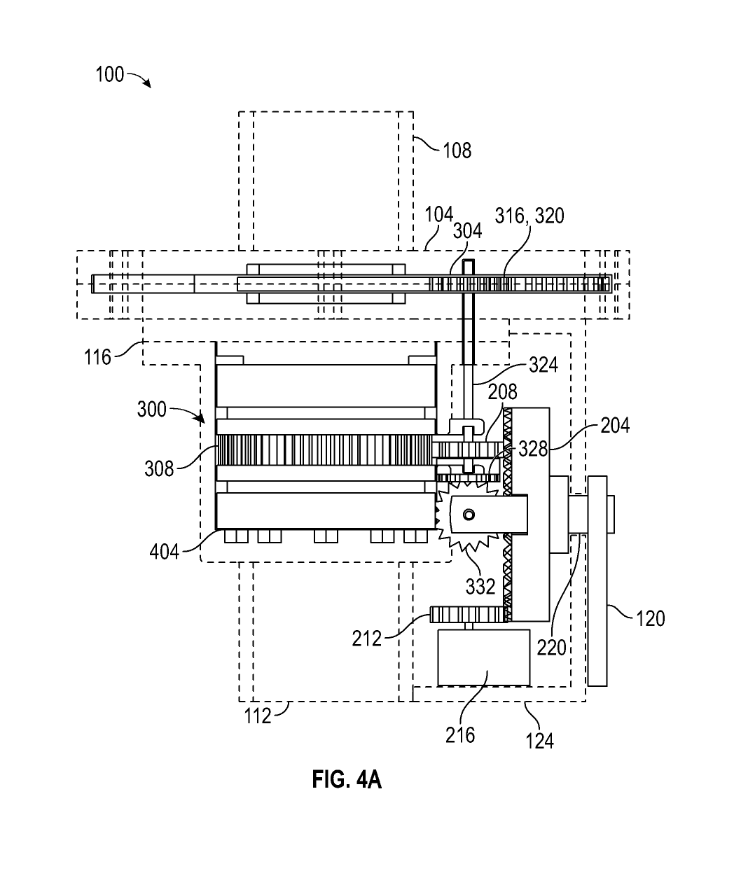

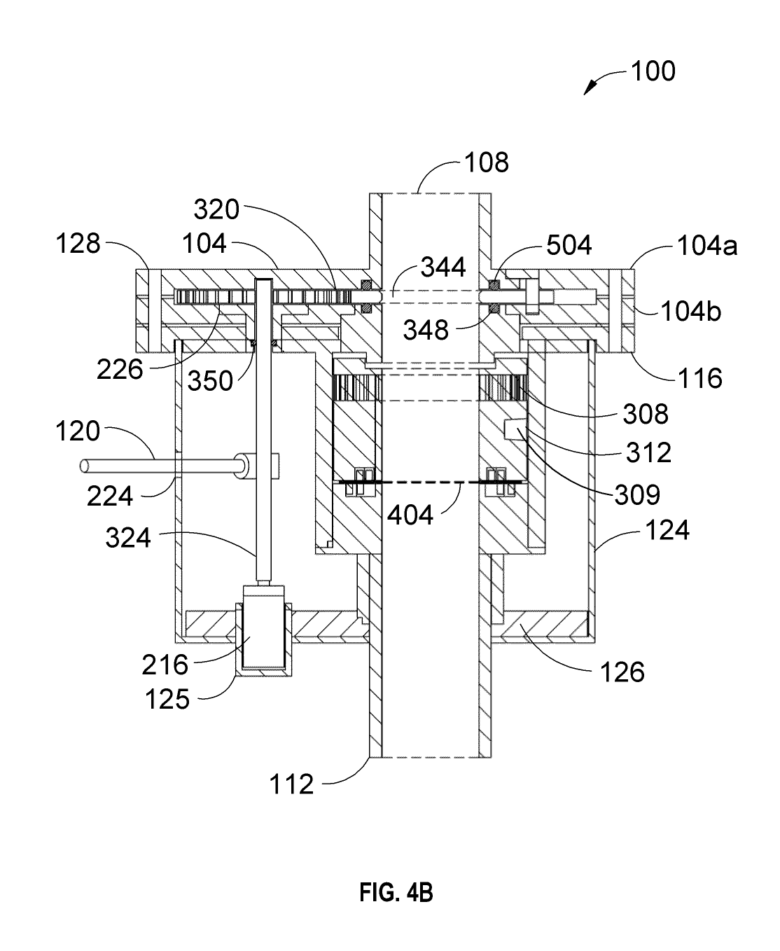

The exemplary valve system 100 shown in FIG. 1A further includes a gear/motor protection cover 124 for housing and/or protecting a gear/motor box. On the outside of the gear/motor box is a handle/indicator 120. The handle/indicator 120 can be used to adjust the size the opening of an iris valve and the position of the slide valve, as will be described below in connection with FIG. 4A.

FIG. 1B illustrates a perspective view of another embodiment of an adjustable orifice valve system 100. In the embodiment depicted in FIG. 1B, the iris valve and slide valve are independently operable by two handles 120. Accordingly, the orifice valve system 100 as depicted in FIG. 1B has two openings 224 to accommodate the handles 120 through the housing 124. Additionally, the embodiment depicted in FIG. 1B includes sample port holes 225 passing through the housing 124 to allow for sampling of the fluid within the valve. The upper flange 104 and lower flange 116 of FIG. 1B are of substantially similar size and shape, such that a single set of joining openings 128 are provided for securing the pieces 104a and 104b of the upper flange 104 to the lower flange 116. In some embodiments, one or more motors for controlling the valves within the valve system 100 may extend beyond boundaries of the housing 124. Accordingly, motor covers 125 at least partially surround and protect the motors.

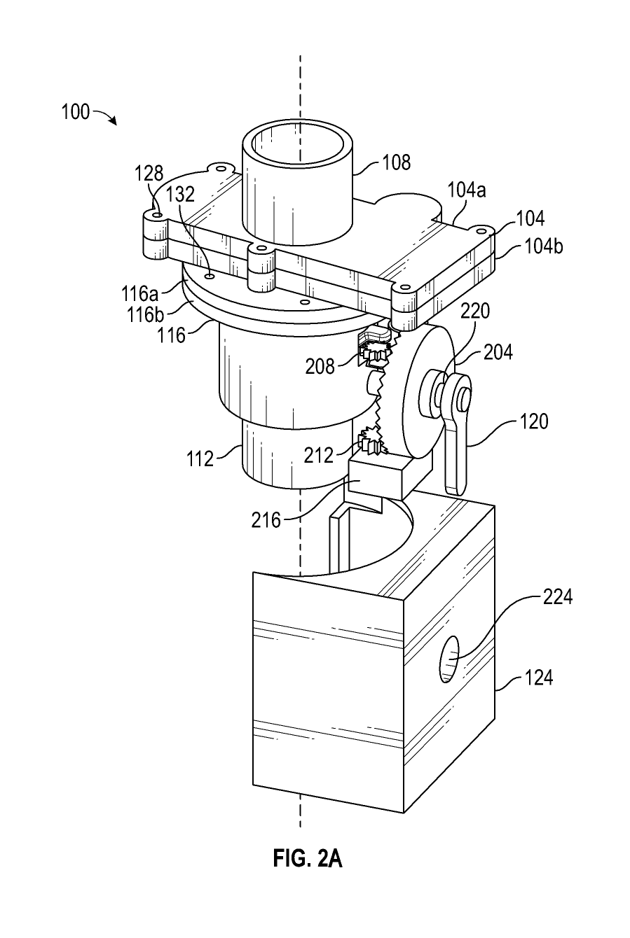

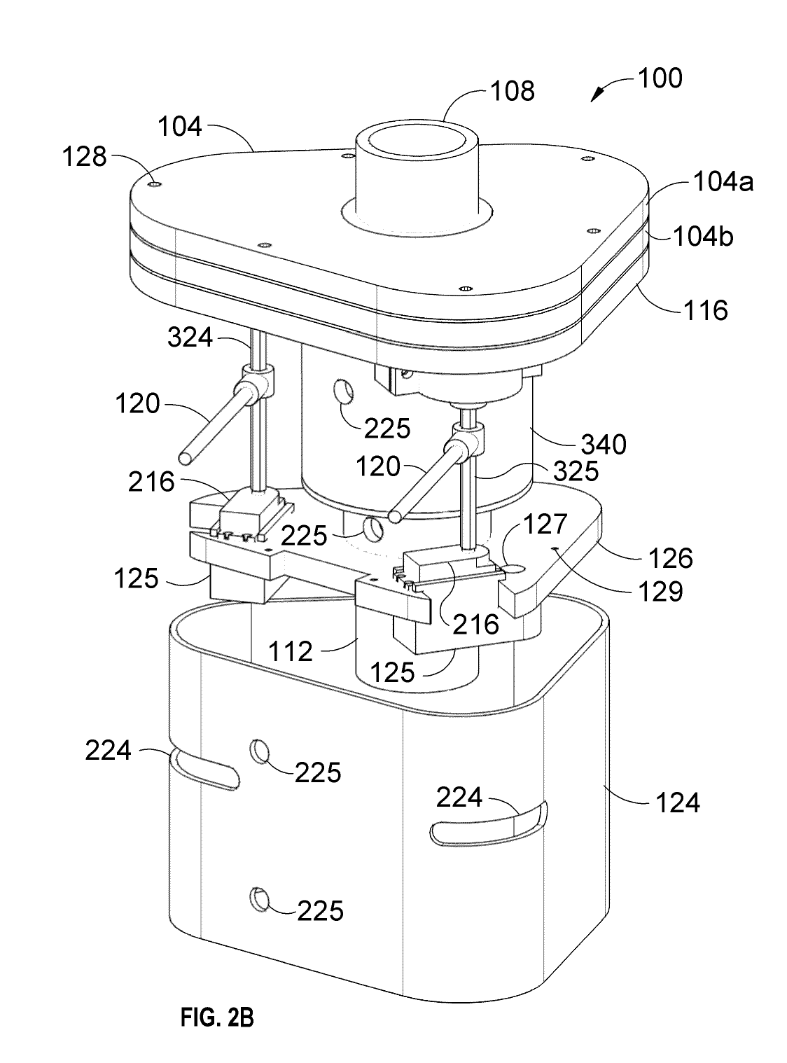

FIG. 2A illustrates a partially exploded view of the embodiment of the valve system 100 of FIG. 1A. As described above with reference to FIG. 1A, the valve system 100 includes an upper flange 104, intake socket 108, outlet socket 112, lower flange 116, handle/indicator 120, gear/motor protective cover 124, and openings 128 and 132. The cover 124 includes an opening 224 through which a crank cylinder 220 connects the handle/indicator 120 with a main control gear wheel 204, such that the main gear control wheel 204 can remain within the protective cover 124 while being connected to the handle/indicator 120 external to the protective cover 124. In this embodiment, the longitudinal axis of the crank cylinder is aligned with the center of the substantially circular main control gear wheel. Rotating the handle 120 in a circular motion causes the crank cylinder 220 and the main control gear wheel 204 to spin around the central longitudinal axis of the crank cylinder 220.

The main control gear wheel 204 has cogs around its outer circumference. An external adjustable orifice gear wheel 208 is substantially circular in shape and has matching cogs around its outer circumference. When assembled in an operational configuration (e.g., a portion of the gears of the wheels 204 and 208 are engaged), the main control gear wheel and the external adjustable orifice gear wheel interface such that rotational motion of the main control gear wheel causes the external adjustable orifice gear wheel to rotate around its central axis, thus translating motion about the central longitudinal axis of the crank cylinder to motion about an axis substantially orthogonal to the longitudinal axis of the crank cylinder.

As an alternative, or addition, to the hand crank, in some embodiments, a motor gear wheel 212 and a motor 216 can be used to control the valve system 100. This will be described below in connection with FIG. 4A.

Although sockets 108 and 112 are referred to as the intake and outlet socket, respectively, the system 100 can also be operable if the direction of fluid flow is the opposite, e.g., if 108 functions as an outlet socket and 112 functions as an intake socket.

FIG. 2B depicts a partially exploded view of the embodiment of the valve system 100 of FIG. 1B. As described above with reference to FIG. 1B, the system 100 includes two handles 120 and corresponding openings 224 in the housing 124. As shown in the partially exploded view of FIG. 2B, motors within motor covers 125 can be supported within the system 100 by a motor support plate 126. The motor support plate 126 includes holes 129 to accommodate fasteners for fastening the motor support plate 126 to the housing 124. Holes 127 are provided to accommodate wiring or other circuitry associated with the motors within motor covers 125. A slide valve rod 324 couples one of the handles 120 and one of the motors in a motor housing 125 to actuate the slide valve, and an iris valve rod 325 couples the other of the handles 120 and motors in a motor housing 125 to actuate the iris valve.

Referring now to the exploded view of FIG. 3A, an iris valve 300 in the adjustable orifice valve system 100 can be used to control the rate of fluid flow through the valve system 100 within a range of flow rates, for example, through the size of an opening 336 of the iris valve 300. In some embodiments, the opening 336 of the iris valve 300 is positioned in-line with the flow axis 380 of the system 100, the flow axis 380 (also referred to herein as a fluid transport path) extending through a central axis of the intake socket 108 and through a central axis of the outlet socket 112. In some embodiments, a slide plate 304 including an opening can be moved to align its opening 344 with the flow axis 380 to permit fluid flow through the system 100. The opening 344 of the slide plate 304 can also be moved away from the flow axis 380 to prevent fluid flow and/or leaks through the system 100.

The exploded view of FIG. 3B further illustrates components of the embodiment of the valve system 100 depicted in FIGS. 1B and 2B. In the exploded view of FIG. 3B, a gear cover 213 is included to support and partially surround gear 212, which adjusts the iris valve 300. The slide valve rod 324 passes through the lower flange 116 at hole 227 to connect to gear 320. A seal 226 (e.g., a plug, o-ring, or the like) prevents leakage around the slide valve rod 324 at the hole 227. Relative to the embodiment of FIG. 3A, the embodiment of FIG. 3B is simplified to exclude gear wheels 204, 208, 332, and 328.

### Internal Slide Valve

In the embodiment depicted in FIG. 3A, the intake socket 108 and the upper piece 104a of the upper flange are formed as a single piece. The lower piece 104b of the upper flange and the upper piece 116a of the lower flange are similarly formed as a single piece. The upper piece 104a and the lower piece 104b of the upper flange define an interior space such that a substantially planar slide valve can be placed between the upper and lower pieces of the upper flange 104. The slide valve has a substantially circular opening 344, but in other embodiments may be shaped differently. For example, a rectangular, or circular on one end and rectangular on the other, slide valves may provide quicker blockage of flow through the system than a circular opening. To allow fluid flow through the system, the slide valve can be positioned such that the opening 344 is aligned with the flow axis 380 (a flow position). To stop fluid flow through the system, the slide valve can be positioned such that the aperture enclosed by an o-ring seal 348 does not overlap with the opening 344 (a no-flow position).

The slide valve has cogs 316 on a portion of its perimeter. The cogs 316 and a substantially circular gear 320 are positioned to engage to form a rack and pinion gear system. The slide valve can be moved between flow/no-flow positions through a chain reaction involving handle/indicator 120, main control gear wheel 204, a first external slide valve gear wheel 328, a second external slide valve gear wheel 332, a slide valve Rod 324, and the gear 320. In some embodiments, these gears can be arranged so that the internal slide valve remains in the flow position throughout most or all of the iris valve's changes between its maximally open and minimally open (or closed) positions, only beginning to move toward the no-flow position when the iris valve reaches its minimally open (or closed) position (or approaches the minimally open (or closed) position). This interaction of the slide valve and iris valve will be described further below in connection with FIG. 4A.

In the embodiment depicted in FIG. 3B, the slide plate 304 is mounted to move in a pivoting motion about a support pin 305, rather than in a linear motion as in the embodiment of FIG. 3A.

### Iris Valve

In this embodiment shown in FIG. 3A, the iris valve 300 includes a substantially cylindrical iris valve housing 312 having an opening 336. An adjustable orifice plate comprising a plurality of fingers (not visible in FIG. 3A) resides within the housing 312. The upper piece of the lower flange 116a has a substantially circular male protrusion encircled by an o-ring seal 352. This male protrusion and the opening 336 are sized to form a fluid-tight seal with the aid of o-ring seal 352. The housing 312 and the opening 340 are sized to form a fluid-tight seal with the aid of o-ring seals 356 and 360. In this example embodiment, apertures of intake socket 108, opening 344 of the slide valve, opening enclosed by o-rings 348 and 352, opening 336 of housing 312, opening 340, and outlet socket 112 are concentric around the flow axis 380.

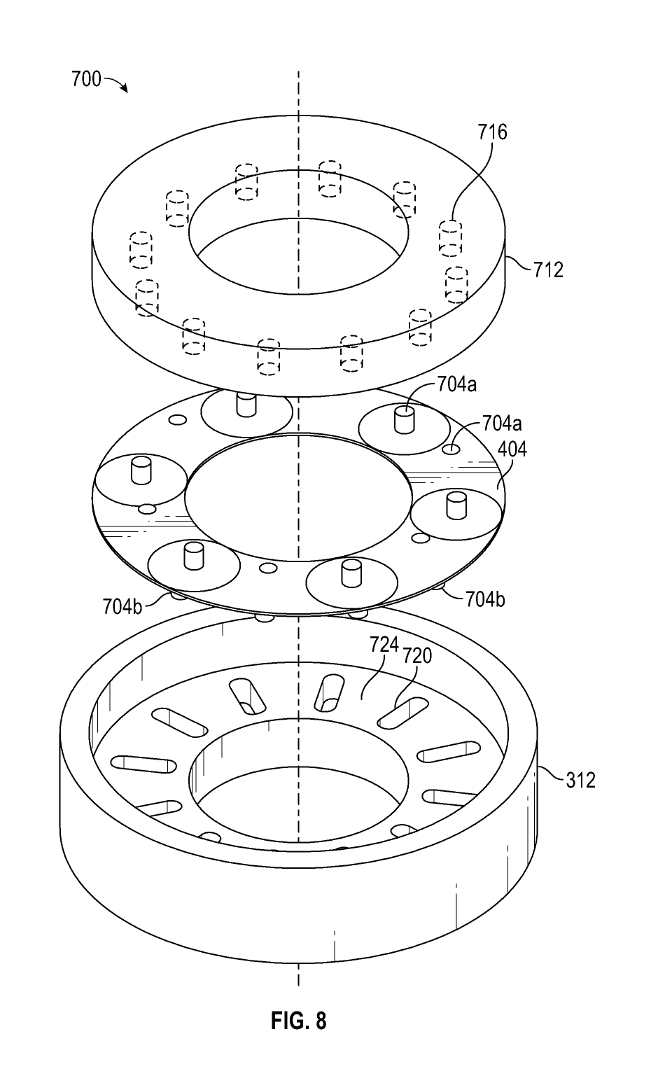

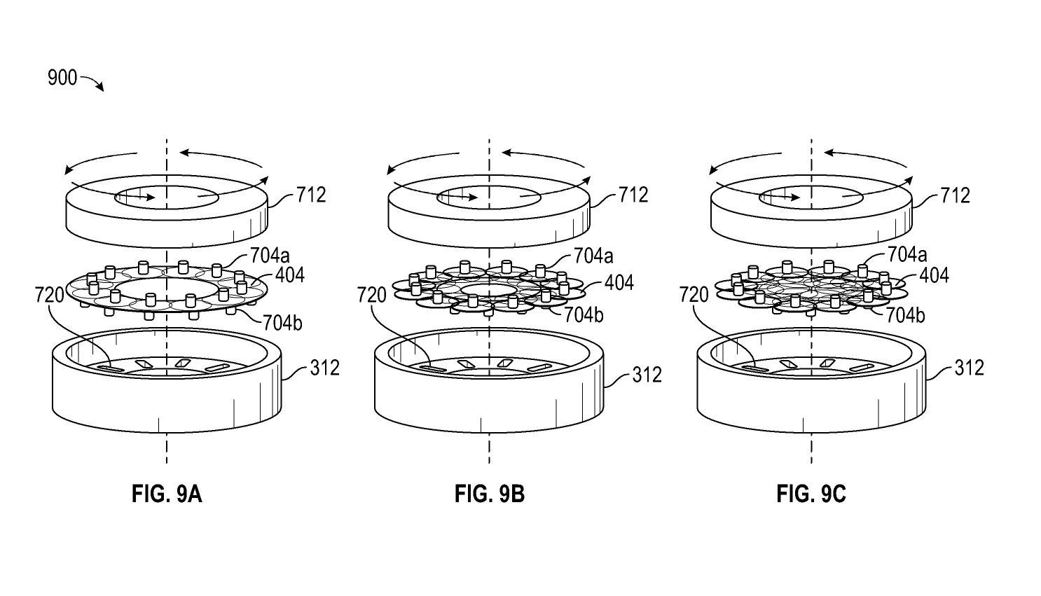

In the embodiment shown in FIG. 3A, the housing 312 comprises an internal adjustable orifice gear wheel 308. The cogs of this gear form a ring on the outer circumference of the housing 312 between the o-rings 356 and 360. When assembled in an operational configuration, an external adjustable orifice gear wheel 208 engages with both the internal adjustable orifice gear wheel 308 and the main control gear wheel 204 such that rotational motion of the main control gear wheel 204 causes the internal adjustable orifice gear wheel 308 to rotate around the flow axis 380. The rotation of the internal adjustable orifice gear wheel 308 enlarges or reduces an aperture of the iris valve 300 as described in connection with FIG. 9 below.

In the embodiment shown in FIG. 3B, the housing 312 of the iris valve 300 further includes a slot 309 located so as to permit access via the sample ports 225.

### Gear Wheel System

FIG. 4A illustrates a cutaway view of the exemplary embodiment of the valve system 100. In this exemplary implementation, the handle/indicator 120 is connected to a crank cylinder 220 such that the crank cylinder rotates around its longitudinal axis when the handle/indicator 120 is rotated. The crank cylinder 220 is connected to a main control gear wheel 204 such that the longitudinal axis of the crank cylinder 220 and the central axis of the main control gear wheel 204 are in-line. The main control gear wheel 204 interfaces with an external adjustable orifice gear wheel 208 in a crossed orientation, e.g., the shafts of the two gear wheels are substantially perpendicular in the cross-sectional view of FIG. 4A. The external adjustable orifice gear wheel 208 interfaces with the internal adjustable orifice gear wheel 308 in a parallel configuration, e.g., the shafts of the two gear wheels are substantially parallel. Rotation of the main control gear wheel 204 causes rotation of the external adjustable orifice gear wheel 208, which in turn causes rotation of the internal adjustable orifice gear wheel 308. The rotation of the internal adjustable orifice gear wheel 308 with respect to the housing 312 of the iris valve 300 causes movement of the adjustable orifice plate 404 and an increase or decrease in size of the aperture of the iris valve 300. Flow rates of fluid through the valve system 100 can be controlled through the size of the iris valve aperture.

The main control gear wheel 204 also interfaces with a second external slide valve gear wheel 332 in a crossed orientation. The second external slide valve gear wheel interfaces with a first external slide valve gear wheel 328 also in a crossed orientation. The two crossed orientations are such that the shaft of the first external slide valve gear wheel 328 is substantially parallel to the shaft of the external adjustable orifice gear wheel 208. A substantially cylindrical slide valve rod 324 is connected to the external slide valve gear wheel 328, with the longitudinal axis of the valve rod in-line with the central axis of the first external slide valve gear 328. The opposite end of the slide valve rod 324 is connected to another gear 320. This multi-gear train as described transfers rotational motion of the handle/indicator 120 to rotational motion of the gear 320. Lastly, the gear 320 and cogs 316 on the internal slide valve form a rack and pinion system. Rotation of the gear 320 causes the internal slide valve to slide in a direction perpendicular to the longitudinal axis of the slide valve rod 324. The opening 344 of the internal slide valve can be moved to allow or to stop fluid flow through sliding the internal slide valve to different positions.

An embodiment of the gear wheel system can be configured such that the opening 344 of the internal slide valve is aligned with the flow axis 380 when the iris valve 300 is not fully closed. To stop the flow of fluid through the system, the gear wheel system first engages to decrease the aperture size of the iris valve 300 to a minimum (e.g. zero or close to zero), then engages to move the internal slide valve to fully and securely block the fluid transport path. To resume the flow of fluid through the system, the gear wheel system can function in the reverse order, e.g., this gear wheel system first engages to move the internal slide valve to align its opening 344 with the flow axis 380, then engages to increase the aperture size of the iris valve 300 from the minimum. A user can turn the handle/indicator 120 by a first amount to control the aperture size (e.g., turning the handle 120 clockwise by 90° (or some other amount, e.g., 75° or 105°) can cause the iris valve 300 to change from a maximally open configuration to a minimally open (or closed) configuration). If engagement of the slide valve is desired, the user can turn the handle/indicator 120 further by a second amount, e.g., 80° clockwise (or some other amount, e.g., 70° or 90°) to move the opening 344 away from the flow axis 380.

The size of the aperture of the iris valve 300 and/or the position of the internal slide valve can be determined from the position of the handle/indicator 120. This determination can be done via calculations using known gear ratios in the system. Thus the handle 120 can serve as a flow rate indicator (hence the name handle/indicator). An implementation can provide further visual indications to a user, e.g., by indicating by markings on the gear/motor protective cover 124 the positions of the handle/indicator 120 corresponding to a fully open configuration (e.g., the opening 344 is aligned with the flow axis 380 and the iris valve has a maximum aperture size), a minimally open configuration (e.g., the opening 344 is aligned with the flow axis 380 and the iris valve has a minimum aperture size), and a fully closed configuration (e.g., the opening 344 is away the flow axis 380 and the iris valve has a minimum aperture size).

The embodiment depicted in FIG. 4B contains generally the same components as the embodiment depicted in FIG. 4A. However, the gear wheel system of the embodiment of FIG. 4B contains fewer gears. More specifically, gears 204, 208, and 332 of FIG. 4A are not present in the embodiment of FIG. 4B. Seal 350 is provided to prevent leakage around the slide valve rod 324. In addition, the slot 309 for sample port access is visible in the iris valve housing 312.

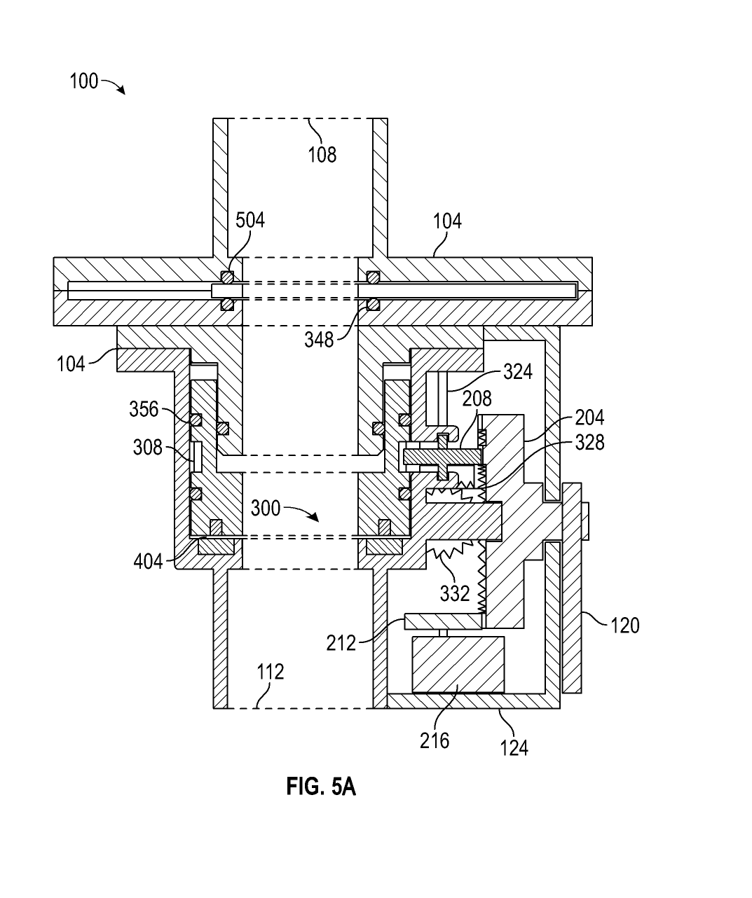

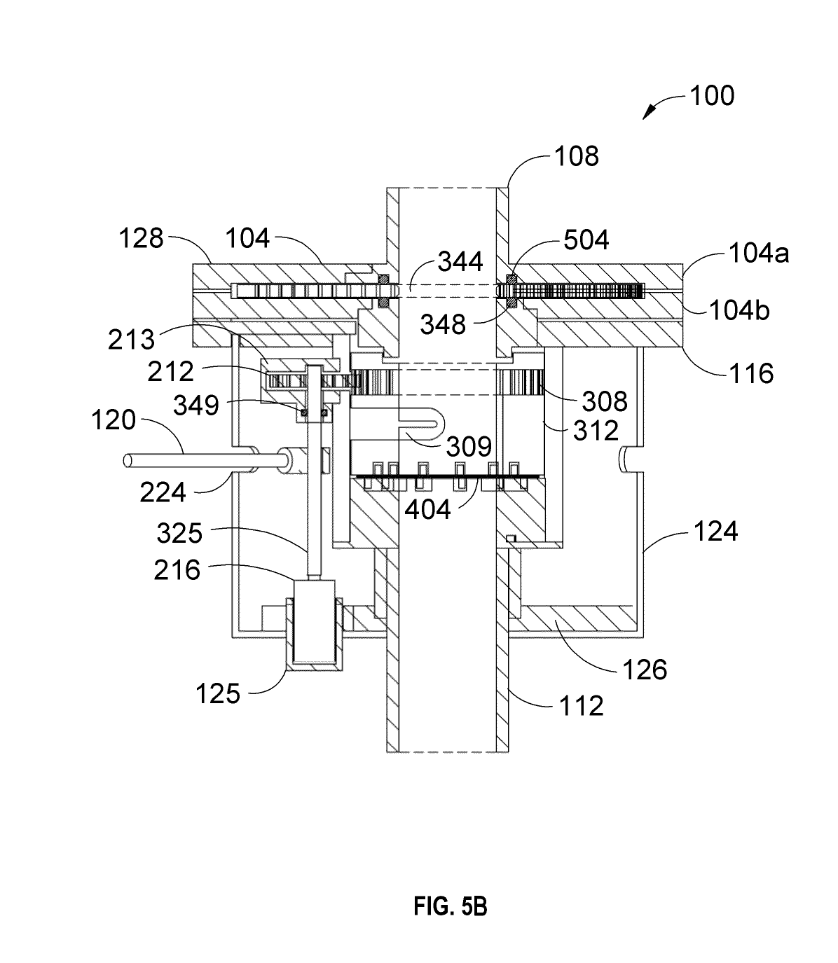

FIG. 5A illustrates a cross sectional view of the embodiment of the valve system 100 shown in FIGS. 3A and 4A. As illustrated in FIGS. 3A, 4A, and 5A, the gears 208, 212, 320, 328, and 332 are spur type gears; gears 204 is a crown gear. However, the illustrations are not limiting. For example, the external slide valve gear wheels 328 and 332 can be implemented as a worm gear, with gear wheel 328 and slide valve Rod 324 being the worm and gear wheel 332 being the worm wheel.

FIG. 5B illustrates a cross sectional view of the embodiment of the valve system 100 shown in FIGS. 3B and 4B. As illustrated in FIG. 5B, the system 100 further includes an additional seal 349 (e.g., an o-ring or the like) around the iris valve rod 325. The seal 349 is disposed within the gear cover 213 to prevent leakage from the valve around the iris valve rod 325. In addition,

### Motor and Sensing

Referring generally to FIGS. 3A-5B, a valve system 100 can rotate the iris valve 300 and/or slide valve via manual rotation of the handle/indicator 120 and/or via rotation driven by a motor 216, e.g., an electric motor. For example, the motor 216 can be oriented so that its shaft is substantially parallel with the slide valve rod 324 and connects with the motor gear wheel 212. When the motor is actuated, its shaft rotates and the motor gear wheel also rotates around its central axis. When assembled in an operational configuration (e.g., the motor gear wheel 212 interfaces with the main control gear wheel 204), the rotation of the motor gear wheel causes the main control gear wheel to rotate. Through the chain reaction described above, the motor 216 can cause movements of the iris valve and of the slide valve. In various embodiments, the motor 216 can be controlled locally, such as by one or more buttons, touch screens, or other input device located on or near the valve system 100. In some embodiments, the motor 216 can be controlled remotely in addition to or instead of local control, for example, the motor can be controlled by an automated valve monitoring system and/or by user input at a computing device at a location away from the valve system 100 (e.g., by wireless communication).

A valve system can also provide sensing capability to determine status of the valve system. For example, with information of the initial relative positions of the internal slide valve and a gear wheel (e.g., 320, 328, 332, or 204) as well as the relative gear ratios of the various gears in the chain, the position of the internal slide valve can be determined from the position and count of the number of rotations of the gear wheel (e.g., 320, 328, 332, or 204). With information of the initial positions of the adjustable orifice plate 404 and of a gear wheel (e.g., 308, 208, or 204), initial position of the housing 312 relative to the internal adjustable orifice gear wheel 308, as well as the relative gear ratios of the various gears in the chain, the position of the adjustable orifice plate 404 can be determined from the position and count of the number rotations of the gear wheel (e.g., 308, 208, or 204). With such sensing capability, the positions of the internal slide valve and of the adjustable orifice plate and the flow rate can be provided to a remote user through a communication channel; a user does not need to visually observe the position of the handle/indicator 120 to determine a present flow rate.

An embodiment can include a pressure transducer in the outlet socket 112 and enable calculation of flow rate from the size of the orifice and the measured pressure. The valve system can advantageously support both flow control and flow rate determination. The pressure measurement can be provided to a remote user through the communication channel. An embodiment can have the pressure measurement and/or the sensing capability.

### Seals

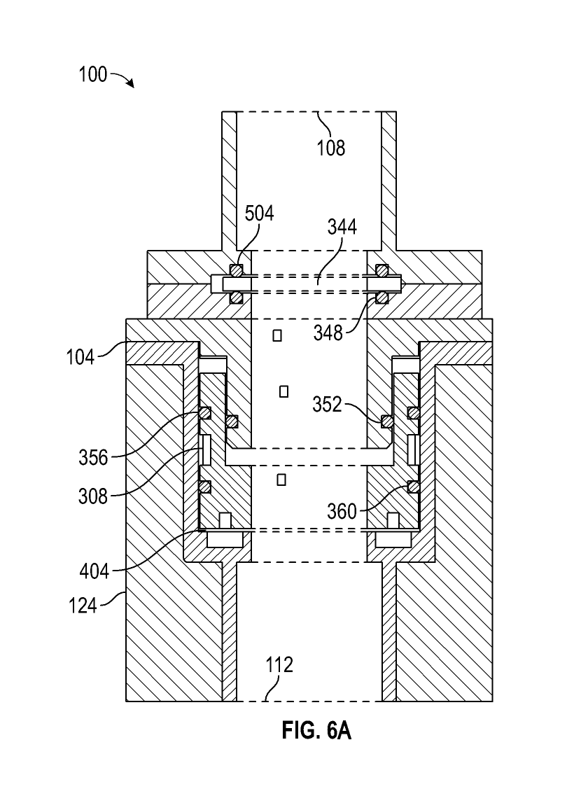

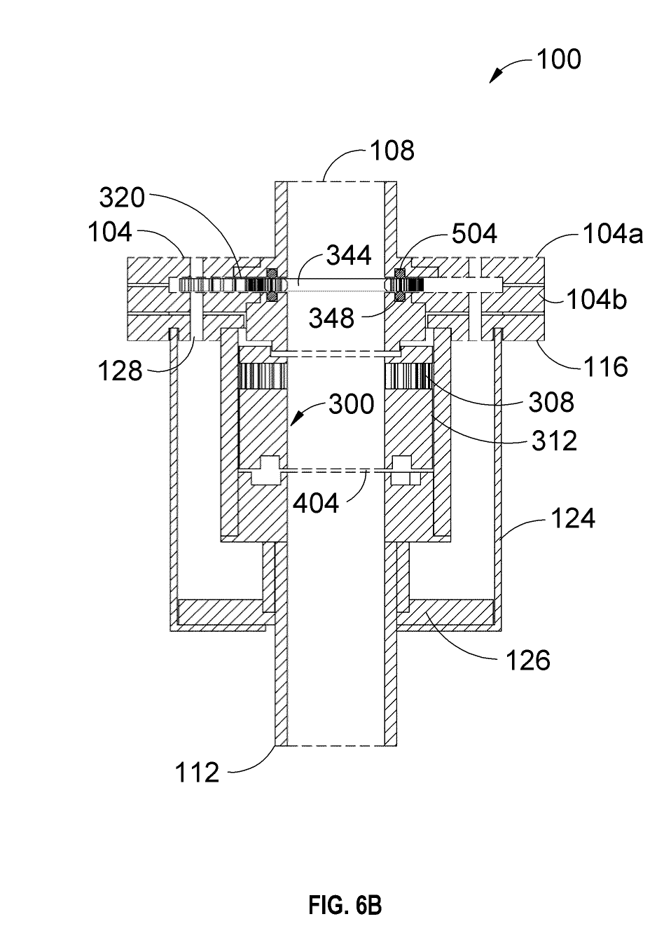

FIG. 6A illustrates another cross sectional view of the embodiment of the valve system 100. Gas flow (or fluid flow) is illustrated as proceeding from intake socket 108 to outlet socket 112 through the opening 344 of a slide valve and an iris valve comprising adjustable orifice plate 404. An o-ring seal 504 is positioned around an intake socket aperture on the upper part 104a of the upper flange. Another o-ring seal 348 is positioned around the aperture on the lower part 104b of the upper flange. These two o-rings create a seal between the internal slide valve and the upper flange 104. A third O-ring seal 352 is placed around the outer circumference of the substantially circular male protrusion of the lower flange. This third o-ring provides a seal between the male protrusion and the opening 336 of housing 312. Two more o-ring seals 356 and 360 are placed on the outer circumference of the housing 312 to create a seal between the housing 312 and the side of the substantially cylindrical opening 340. The o-rings help prevent fluid from leaking out of their respective enclosures, especially when the internal slide valve is sliding or when the internal adjustable orifice gear wheel 308 is rotating. It can be desirable to prevent the fluid from leaking, for example, either out of the valve system 100 or into the gear/motor housing, with or without passing through a filter.

In the embodiment depicted in FIG. 6B, corresponding to the embodiments depicted in FIGS. 1B, 2B, 3B, 4B, and 5B, the design is simplified such that certain seals depicted in FIG. 6A are not present. More specifically, o-ring seals 352 and 360 shown in FIG. 6A are not present in the embodiment of FIG. 6B.

### Adjustable Orifice Plate

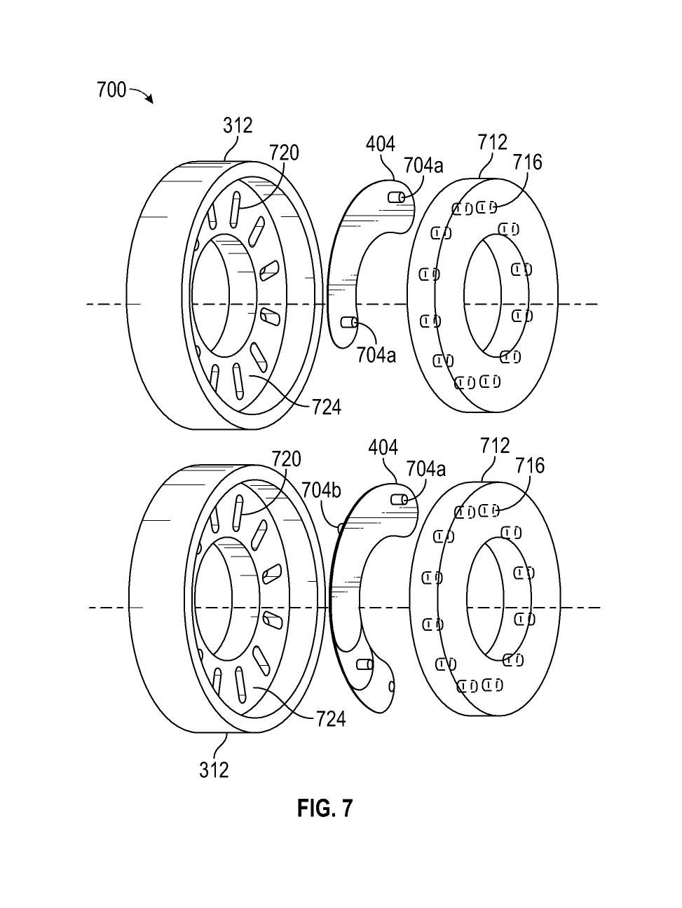

FIG. 7 illustrates the adjustable orifice plate 404 and an adjustment mechanism. In the embodiment depicted, the adjustable orifice plate 404 comprises a plurality (e.g. between 6 and 12, or a larger or smaller number) of finger-shaped plates (fingers). Each finger has a substantially planar shape with two pins 704a, 704b protruding from each side of the plane. The pins 704a are substantially cylindrical in shape and are located close to the two ends of the fingers. The adjustment mechanism comprises the housing 312 and a rotator ring 712. The housing 312 and the rotator ring 712 are both substantially cylindrical in shape and are positioned concentrically in an operational configuration. The rotator ring is sized such that it can be placed within the interior circular wall of housing 312. The rotator ring 712 has a plurality of substantially cylindrical openings 716. The longitudinal axes of openings 716 are substantially parallel to the central axis of the rotator ring. The housing 312 has a plurality of slotted openings 720 on an inner planar surface 724. The slotted openings 720 extend radially from the central axis to the outer circumference of housing 312. The portion of the pins 704a, 704b to be mated with openings 716 in rotator ring 712 is designated 704a. The portion of the pins 704a, 704b to be mated with openings 720 in housing 312 is designated 704b. When assembled in an operational configuration, a pin 704a is inserted into an opening 716. Pin 704a fits snugly within opening 716 and can rotate around the longitudinal axis within the opening. A pin 704b is inserted to a slotted opening 720 such that when pin 704a rotates within an opening 716, the pin 704b slides through the slotted opening 720. The fingers are held in position between the rotator ring 712 and the inner planar surface 724 of housing 312 through pins 704a and 704b and openings 716 and 720.

FIG. 8 illustrates the adjustable orifice plate 404 in a fully open configuration. In this configuration of an embodiment, a finger overlaps with the adjacent fingers within the width of the fingers. The plurality of fingers forms a ring with a substantially circular aperture. The pins 704b are located toward the end of slotted openings 720 close to the outer circumference of housing 312.

FIGS. 9A-9C illustrate opening and closing of the adjustable orifice plate 404. FIG. 9A shows the adjustable orifice plate 404 in a fully open configuration. Relative rotational motion between rotator ring 712 and housing 312 (e.g., turning the rotator ring counterclockwise relative to the housing) causes pins 704a to rotate within openings 716 (not visible) and pins 704b to slide toward the central axis of housing 312. As a result, the fingers move in such a way that the aperture within the adjustable orifice plate 404 decreases in size. Rotation of the internal adjustable orifice gear wheel 308 can cause relative rotational motion between rotator ring 712 and housing 312. FIG. 9B shows the adjustable orifice plate 404 in a partially open configuration. In this embodiment, the plurality of fingers forms a ring with a substantially circular aperture in a partially open configuration. Further relative rotational motion between rotator ring 712 and housing 312 in the same direction causes pins 704a to further rotate within openings 716 and pins 704b to further slide toward the central axis of housing 312. FIG. 9C shows the adjustable orifice plate 404 in a fully closed configuration. Range of rotational motion between rotator ring 712 and housing 312 can be limited by the radial length of the slotted openings 720 or by the edge of a finger coming into contact with pins of an adjacent finger.

The size of the aperture in the fully open configuration can vary depending on the application. For example, a valve system may have an aperture with a maximum size ranging from 25% to 75% of the pipe opening. As another example, in a fluid delivery system with oversized pipes, a valve system may have an aperture with a maximum sizes ranging from 25% to 45% of the pipe opening.

The embodiments described above are examples of the system and method. The following claims define the scope of the invention and include the full range of equivalents to which the recited elements of the claims are entitled.

The foregoing description details certain embodiments of the systems, devices, and methods disclosed herein. It will be appreciated, however, that no matter how detailed the foregoing appears in text, the devices and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated. The scope of the disclosure should therefore be construed in accordance with the appended claims and any equivalents thereof.

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

In general, the microprocessors and/or computing discussed herein may each include on or more “components” or “modules,” wherein generally refer to logic embodied in hardware or firmware, or to a collection of software instructions, possibly having entry and exit points, written in a programming language, such as, for example, Java, Lua, C or C++. A software module can be compiled and linked into an executable program, installed in a dynamic link library, or can be written in an interpreted programming language such as, for example, BASIC, Perl, or Python. It will be appreciated that software modules can be callable from other modules or from themselves, and/or can be invoked in response to detected events or interrupts. Software modules configured for execution on computing devices can be provided on a computer readable medium, such as a compact disc, digital video disc, flash drive, magnetic disc, or any other tangible medium, or as a digital download (and can be originally stored in a compressed or installable format that requires installation, decompression or decryption prior to execution). Such software code can be stored, partially or fully, on a memory device of the executing computing device, for execution by the computing device. Software instructions can be embedded in firmware, such as an EPROM. It will be further appreciated that hardware modules can be comprised of connected logic units, such as gates and flip-flops, and/or can be comprised of programmable units, such as programmable gate arrays or processors. The modules or computing device functionality described herein are preferably implemented as software modules, but can be represented in hardware or firmware. Generally, the modules described herein refer to logical modules that can be combined with other modules or divided into sub-modules despite their physical organization or storage.

The term “non-transitory media,” and similar terms, as used herein refers to any media that store data and/or instructions that cause a machine to operate in a specific fashion. Such non-transitory media can comprise non-volatile media and/or volatile media. Non-volatile media includes, for example, optical or magnetic disks, such as storage device. Volatile media includes dynamic memory, such as main memory. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

It is noted that the examples may be described as a process. Although the operations may be described as a sequential process, many of the operations can be performed in parallel, or concurrently, and the process can be repeated. In addition, the order of the operations may be rearranged. A process is terminated when its operations are completed. A process may correspond to a method, a function, a procedure, a subroutine, a subprogram, etc.

The previous description of the disclosed implementations is provided to enable any person skilled in the art to make or use the present disclosed process and system. Various modifications to these implementations will be readily apparent to those skilled in the art, and the generic principles defined herein may be applied to other implementations without departing from the spirit or scope of the disclosed process and system. Thus, the present disclosed process and system is not intended to be limited to the implementations shown herein but is to be accorded the widest scope consistent with the principles and novel features disclosed herein.

What is claimed is:

1. A flow control valve comprising:
an intake socket;
an outlet socket;
an iris valve configured for positioning between the intake socket and the outlet socket, comprising adjustable orifice plates with planes substantially perpendicular to a flow axis of the flow control valve such that the adjustable orifice plates define an aperture; and
a slide valve configured for positioning between the intake socket and the outlet socket, configured to slide in a direction substantially perpendicular to the flow axis of the flow control valve;
wherein a gear wheel mechanism engages the iris valve to adjust size of the aperture through rotational motion, and
wherein the gear wheel mechanism engages the slide valve for sliding motion.

2. The flow control valve of claim 1, wherein the gear wheel mechanism is configured to engage the slide valve for sliding motion when the iris valve is in a minimally open configuration.

3. The flow control valve of claim 1, wherein the gear wheel mechanism is configured to engage the iris valve to adjust the size of the aperture when the slide valve is in an open position.

4. The flow control valve of claim 1, further comprising:
a housing at least partially enclosing the gear wheel mechanism; and
a handle coupled through the housing to actuate the gear wheel mechanism.

5. The flow control valve of claim 4, wherein the housing comprises an exterior surface having one or more markings configured to visually indicate, based on a position of the handle, one or more of a size of the aperture, an open or closed position, or a fluid flow rate.

6. The flow control valve of claim 4, wherein a continuous motion of the handle consecutively induces a sliding motion of the slide valve and an aperture size adjustment of the iris valve.

7. The flow control valve of claim 1, further comprising a motor coupled to the gear wheel mechanism, wherein the motor is configured to actuate the gear wheel mechanism.

8. The flow control valve of claim 1, further comprising a valve position sensor configured to produce an output indicative of a size of the aperture.

9. The flow control valve of claim 1, further comprising a pressure sensor configured to produce an output indicative of a fluid pressure within an interior space of the flow control valve.

10. The flow control valve of claim 9, further comprising processing circuitry configured to calculate a rate of fluid flow through the flow control valve based at least in part on the output of the pressure sensor.

11. A fluid flow control device comprising:
a housing generally defining a fluid space, the housing comprising:
a fluid inlet; and
a fluid outlet spaced from the fluid inlet along a fluid flow axis;
coarse adjustment means for coarsely adjusting a flow rate along the fluid flow axis; and
fine adjustment means for finely adjusting the flow rate along the fluid flow axis;
wherein the coarse adjustment means and the fine adjustment means are at least partially disposed within the housing along the fluid flow axis.

12. The fluid flow control device of claim 11, wherein the coarse adjustment means is configured to substantially prevent fluid flow through the fluid flow control device when in a closed position.

13. The fluid flow control device of claim 11, wherein the fine adjustment means comprises one or more structures defining an aperture and means for adjusting a diameter of the aperture.

14. The fluid flow control device of claim 11, wherein the coarse adjustment means is configured to transition between a closed position and a fully open position when the fine adjustment means is in a minimally open position.

15. The fluid flow control device of claim 11, wherein the fine adjustment means is configured to transition between a fully open position and a minimally open position when the coarse adjustment means is in a fully open position.
